(19) United States
(12) Patent Application Publication
(10) Pub. No.: US 2025/0118792 A1
(43) Pub. Date: Apr. 10, 2025

(54) Structured Electrode, Preparation Method Therefor and Use Thereof

(71) Applicant: South China University of Technology, Guangzhou, Guangdong (CN)

(72) Inventors: Wei YUAN, Guangzhou, Guangdong (CN); Yintong YE, Guangzhou, Guangdong (CN); Yang YANG, Guangzhou, Guangdong (CN); Xinzhu GAO, Guangzhou, Guangdong (CN); Chun WANG, Guangzhou, Guangdong (CN); Xiaoqing ZHANG, Guangzhou, Guangdong (CN)

(73) Assignee: South China University of Technology, Guangzhou, Guangdong (CN)

(21) Appl. No.: 18/721,821

(22) PCT Filed: Nov. 15, 2022
(86) PCT No.: PCT/CN2022/131982

§ 371 Date: Jun. 19, 2024

(30) Foreign Application Priority Data
Mar. 15, 2022 (CN) 202210251512.X

(51) Int. Cl. H01M 10/0525; H01M 4/139; H01M 10/054

(52) U.S. Cl. CPC H01M 10/0525; H01M 4/139; H01M 10/054

(57) ABSTRACT

The present invention relates to the technical field of electrochemistry, and in particular, to a structured electrode, a preparation method therefor and a use thereof. The structured electrode of the present invention comprises an electrode body, and a surface of the electrode body is provided with an etched structure; and the electrode body is of an array structure composed of three-dimensional electrode wires. According to the structured electrode of the present invention, the electrode body is prepared by means of etching and 3D printing, and structure re-modification is performed, so that a larger specific surface area of the electrode is obtained; and an electrolyte storage region of a larger volume is constructed, so that the electrolyte can better wet the surface of the electrode, a transport path for alkali metal ions/electrons is shortened to a certain extent, and the conductivity of the electrode is improved, thereby helping to improve the charge-discharge specific capacity and the rate capability of an alkali metal secondary battery.

### TECHNICAL FIELD

The present disclosure relates to the technical field of electrochemistry, and in particular to a structured electrode, a preparation method therefore and use thereof.

### BACKGROUND

With the increasing demand for energy storage devices, electrochemical energy storage systems based on alkali metal batteries have become the development direction of the new generation of energy storage systems. Traditional alkali metal batteries have limited cycle life due to poor flexibility in planar electrodes, easily cracked slurry after bending, and easily fallen active materials during charging and discharging.

Without requiring templates, an object with a certain thickness and shape may be prepared efficiently and controllably through 3D printing in a manner of depositing the active materials onto a substrate layer by layer. Laser processing, precisely controlled by processing parameters, is performed at specific locations with specified power, producing electrodes with a required structure in a highly controllable manner. Novel electrodes with three-dimensional structures for the alkali metal batteries can be prepared by both 3D printing and laser processing technologies. While increasing the active material loading, the novel electrodes can shorten a diffusion distance of alkali metal ions during charging and discharging, accelerate a diffusion speed of the alkali metal ions and electrons, improve the conductivity of the electrodes, and enhance electrochemical performance of batteries.

In related technologies, the 3D printing technology is used to prepare tin-carbon anodes and lithium iron phosphate cathodes for lithium-ion batteries, which can change the traditional planar electrodes and shorten a migration distance of lithium ions, and does not need to make further structural modifications to the 3D-printed electrodes. In the related technologies, a method for manufacturing three-dimensional structural batteries through ultrafast lasers is also used to control the ultrafast lasers to form preset micro-nano patterns on the electrodes prepared in a planar form, and further processing on the three-dimensional electrodes by using the laser processing method is not considered. The electrodes prepared by the above two methods still have problems of poor rate performance and low specific capacity.

Therefore, it is necessary to develop a structured electrode with good rate performance and high specific capacity.

### SUMMARY

In order to solve the problems existing in the prior art, the present disclosure provides a structured electrode, which has good rate performance and high specific capacity.

The present disclosure further provides a preparation method for the structured electrode as described above.

The present disclosure further provides use of the structured electrode as described above in an alkali metal battery.

A first aspect of the present disclosure provides a structured electrode, which includes an electrode body, wherein a surface of the electrode body is provided with an etched structure; and the electrode body is an array structure composed of three-dimensional electrode wires.

According to at least one embodiment of the present disclosure, it has at least the following beneficial effects.

In the present disclosure, the electrode body is processed by laser etching to form an etched structure on the surface of electrode, and the etched structure constructs an electrolyte storage area with a greater volume, so that the electrolyte can better wet the surface of the structured electrode, thus shortening the transmission path of alkali metal ions, accelerating a diffusion rate of the alkali metal ions, improving conductivity of the structured electrode, and also shortening a diffusion path of the alkali metal ions to reduce electrochemical impedance of the alkali metal ion battery, thereby improving the charge-discharge specific capacity of the alkali metal battery.

The structured electrode provided by the present disclosure increases the active material loading, shortens the diffusion distance of the alkali metal ions during charging and discharging, accelerates the diffusion rate of the alkali metal ions, and improves the conductivity of the electrode, thereby helping to enhance the charge-discharge specific capacity and rate performance of the alkali metal battery.

Compared with a planar electrode, the electrode prepared through the 3D printing technology can be stacked in multiple layers under a same electrode area, thereby increasing the active material loading of the electrode.

According to some embodiments of the present disclosure, the electrode body is at least one selected from the group consisting of a line array, a ring array and a grid array.

According to some embodiments of the present disclosure, the line array consists of a plurality of three-dimensional electrode wires.

According to some embodiments of the present disclosure, the three-dimensional electrode wires are 0.1 mm-1 mm in width.

A diameter of a nozzle for 3D printing is 0.05 mm-5 mm, and a diameter of a conventional electrode sheet is 12 mm-15 mm, therefore the diameter of the nozzle cannot be too large, and the width of the 3D printed electrode wires is not too large due to a limitation of the diameter of nozzle.

According to some embodiments of the present disclosure, the electrode body has a width of 0.1 mm-2 mm.

According to some embodiments of the present disclosure, a spacing between the three-dimensional electrode wires is 2-8 times of the width of the electrode body.

The spacing at blanks between the electrode array lines are extruded during the 3D printing.

The electrode wires are not limited in length, the specific length depends on the diameter of the electrode sheet used, both the width and height are related to the printing parameters used during 3D printing, and a spacing between the adjacent electrode wires is related to printing intervals set during 3D printing.

According to some embodiments of the present disclosure, a spacing between adjacent three-dimensional electrode wires is 1.2 mm-1.5 mm.

According to some embodiments of the present disclosure, the three-dimensional electrode wires are 0.15 mm-0.6 mm in width.

According to some embodiments of the present disclosure, the three-dimensional electrode wires are 0.15 mm-0.6 mm in thickness.

The width of the electrode wires cannot be set too small, otherwise an electrode collapse may be caused due to insufficient electrode strength after subsequent laser etching is performed.

According to some embodiments of the present disclosure, the etched structure includes at least one selected from the group consisting of a line array, a grid array and a hole array.

According to some embodiments of the present disclosure, the line array includes at least one selected from the group consisting of a linear array, a diagonal array and a curved array.

According to some embodiments of the present disclosure, the linear array consists of a plurality of straight lines.

According to some embodiments of the present disclosure, a spacing between adjacent straight lines is 0.3 mm-0.5 mm.

According to some embodiments of the present disclosure, the spacing between the adjacent straight lines is 0.4 mm.

According to some embodiments of the present disclosure, the straight lines are 80 μm-120 μm in depth.

According to some embodiments of the present disclosure, the straight lines are 100 μm in depth.

According to some embodiments of the present disclosure, the curved array includes square spiral lines.

According to some embodiments of the present disclosure, a spacing between connected spiral lines in the square spiral line is 1.4 mm-1.6 mm.

According to some embodiments of the present disclosure, the spacing between the connected spiral lines in the square spiral line is 1.5 mm.

According to some embodiments of the present disclosure, the grid array includes at least one selected from the group consisting of a rectangular array and a trapezoidal array.

According to some embodiments of the present disclosure, the rectangular array consists of a plurality of rectangles.

According to some embodiments of the present disclosure, a spacing between adjacent rectangles is 0.8 mm-1.2 mm.

According to some embodiments of the present disclosure, the spacing between the adjacent rectangles is 1 mm.

According to some embodiments of the present disclosure, the rectangles are 0.1 mm-0.3mm in width.

According to some embodiments of the present disclosure, the rectangles are 0.2 mm in width.

According to some embodiments of the present disclosure, the rectangles are 80 μm-120 μm in depth.

According to some embodiments of the present disclosure, the rectangles are 100 μm in depth.

According to some embodiments of the present disclosure, the hole array includes at least one selected from the group consisting of a blind hole array and a through hole array.

According to some embodiments of the present disclosure, a hole in the hole array has a diameter of 1.4 mm-1.6 mm.

According to some embodiments of the present disclosure, a hole in the hole array has a diameter of 1.5 mm.

According to some embodiments of the present disclosure, the blind hole array includes at least one selected from the group consisting of a circular blind hole array, a square blind hole array, and a special-shaped blind hole array.

According to some embodiments of the present disclosure, the through hole array includes at least one selected from the group consisting of a circular through hole array, a square through hole array and a special-shaped through hole array.

According to some embodiments of the present disclosure, an etched line width of the etched structure is 10%-100% of the width of the three-dimensional electrode wires in the electrode body.

According to some embodiments of the present disclosure, a spacing between adjacent units in the etched structure is 1-10 times of the etched line width.

If the etched line width of the etched structure is too large, the insufficient strength of the etched electrode body will be caused, thus leading to the electrode collapse; and therefore the etched line width is generally set to 10%-100% of the line width of the array of electrode body.

According to some embodiments of the present disclosure, an etched depth is 80 μm-120 μm.

According to some embodiments of the present disclosure, the etched depth is 100 μm.

Since laser processing has a thermal effect, part of the electrode body array line structure on a periphery of an etching position will also be etched. Therefore, if an etching spacing is set too small, all the surface layers of the electrode array line structure will be etched, thus not forming the desired etched structure. In addition, since the batteries prepared in the experiment are all button cells which comprise electrode sheets with a diameter of 12-15 mm, if the selected etching spacing is too large, sufficient etched structures cannot be etched in a limited area, which will lead to an unapparent performance improvement effect.

According to some embodiments of the present disclosure, raw materials for preparing the electrode body include: an electrode material, a conductive agent, an adhesive and a solvent.

According to some embodiments of the present disclosure, the electrode body includes the following preparation raw materials in parts by weight: 60-90 parts of electrode material, 5-20 parts of conductive agent and 5-20 parts of adhesive.

According to some embodiments of the present disclosure, the electrode material is an alkali metal battery electrode material.

According to some embodiments of the present disclosure, the alkali metal battery electrode material includes a lithium-ion electrode material and a sodium-ion electrode material.

According to some embodiments of the present disclosure, the lithium-ion electrode material is at least one selected from the group consisting of lithium iron phosphate, lithium manganese phosphate, lithium manganate, lithium iron silicate, lithium manganese silicate, lithium nickel cobalt manganese oxide, lithium nickel manganate and lithium titanate.

According to some embodiments of the present disclosure, the sodium-ion electrode material includes at least one selected from the group consisting of hard carbon and titanium dioxide.

According to some embodiments of the present disclosure, the conductive agent includes at least one selected from the group consisting of acetylene black, carbon black, graphene, carbon fiber, carbon nanotube, Fe powder, Cu powder, Ag powder and Ni powder.

According to some embodiments of the present disclosure, the adhesive includes at least one selected from the group consisting of polytetrafluoroethylene, low-pressure polyethylene, polyvinylidene fluoride and polyvinyl alcohol.

According to some embodiments of the present disclosure, the solvent includes water or N-methylpyrrolidone.

A second aspect of the present disclosure provides a preparation method for the structured electrode above-mentioned, which includes the following steps: printing the electrode body on a surface of a current collector by 3D printing, then etching the electrode body with a laser device, and drying the electrode body;
where the drying is conducted at a temperature of 50° C.-150° C. for 4 h-12 h.

According to at least one embodiment of the present disclosure, it has the following beneficial effects.

In the preparation method provided by the present disclosure, two simply operated and highly controllable processing technologies: 3D printing and laser processing are used, to quickly and accurately process an electrode with a specific three-dimensional structure. Compared with the preparation methods in related technologies, this preparation method is environmentally friendly and low in cost, etc.

In the preparation process of the present disclosure, although different laser devices with different laser processing parameters are used, the etched structure that is etched by the laser device is in a three-dimensional spatial coordinate system. The etching structure is prepared by etching in a direction perpendicular to a substrate of the highly conductive current collector with a laser device, with a top surface of the electrode body as a reference surface, and an upper limit of the etched depth is a thickness of the electrode body.

In the present disclosure, 3D printing is combined with laser processing, so the three-dimensional electrodes with different shapes are printed through the 3D printing technology, then etched by using the laser device, and re-modified, thereby preparing a 3D printing-laser composite processing structured electrode.

According to some embodiments of the present disclosure, the current collector includes any one selected from the group consisting of copper foil, aluminum foil, nickel foam, copper foam and carbon cloth.

According to some embodiments of the present disclosure, the current collector is 35 μm-2000 μm in thickness.

According to some embodiments of the present disclosure, a preparation method of the electrode body includes the following steps: mixing the electrode material, the conductive agent, the adhesive and the solvent, and defoaming a resulting mixture to obtain a mixed slurry.

According to some embodiments of the present disclosure, the mixing is conducted at a stirring speed of 2000 rmp-3000 rpm.

According to some embodiments of the present disclosure, the mixing is conducted for 10 min-60 min.

According to some embodiments of the present disclosure, the defoaming is conducted at a stirring speed of 1000 rmp-3000 rpm.

According to some embodiments of the present disclosure, the defoaming is conducted for 5 min-60 min.

According to some embodiments of the present disclosure, the laser device includes at least one selected from the group consisting of a semiconductor laser device and a carbon dioxide laser device.

According to some embodiments of the present disclosure, the 3D printing has the following process parameters: a printing speed of 5 mm/s-60 mm/s; a pressure of 5 psi-80 psi; and a horizontal height between the nozzle and the current collector of 0.1 mm-1 mm.

A third aspect of the present disclosure provides an alkali metal battery, including the structured electrode as described above.

According to at least one implementation method of the present disclosure, it has the following beneficial effects.
1. Compared with the conventional three-dimensional electrodes prepared by 3D printing, the structured electrode (3D printing-laser composite processing structured electrode) provided by the present disclosure is further etched by a laser device to form an etched structure on the surface of electrode, which is conducive to constructing an electrolyte storage area with a greater volume, allowing the electrolyte to better wet the surface of electrode.
2. Compared with traditional planar electrodes, the structured electrode of the alkali metal battery provided by the present disclosure shortens the transmission path of the alkali metal ions, accelerates the diffusion rate of progressive ions, and improves the conductivity of the electrode, thereby improving the charge-discharge specific capacity of alkali metal ion batteries. The effect of improving the charge-discharge specific capacity is achieved in a manner that laser composite is performed again on the 3D-printed structured electrode to process various types of grooves in order to achieve the effect of improving the electrode surface area.
3. The structured electrode provided by the present disclosure has etched structures of different shapes, which increases the specific surface area of the three-dimensional electrode, provides a buffer space for the volume expansion of the electrode during the charging and discharging, thereby improving the mechanical structural stability of the three-dimensional electrode (that is, the structured electrode provided by the present disclosure), and improving the reversible capacity and capacity stability of the battery.
4. The capacity retention rate in the present disclosure reaches 37.47%; while the capacity retention rate in the comparative example is only 35.56%.

There are many factors that affect the capacity retention rate of lithium-ion batteries, including decomposition of the electrolyte, formation of a solid electrolyte interface (SEI) film, structural characteristics of the electrode, etc. The electrode with a larger specific surface area will have a larger area in contact with the electrolyte, then more SEI films will be generated and more electrolyte will be consumed, resulting in a loss of the battery capacity and a decrease in the capacity retention rate. The specific surface area of the structured electrode prepared in the present application is larger than that of the 3D printed array line electrode, so more electrolyte will be consumed during charging and discharging, resulting in more capacity loss. However, compared with 3D printed array line electrode, the structured electrode has an etched structure that buffers the volume expansion of active materials during charging and discharging, therefore the structured electrode has a better structural stability, which improves the capacity retention rate of the electrode. To sum up, the capacity retention rate of the lithium-ion batteries is affected by many factors, so a further optimization method is required to significantly improve the capacity retention rate of the electrode.

### BRIEF DESCRIPTION OF DRAWINGS

FIG. 1 is a schematic structural diagram of a 3D printing-laser composite processing structured electrode for an alkali metal battery prepared in Example 1 of the present disclosure.

FIG. 2 is a scanning schematic diagram of a three-dimensional structure of a 3D printing-laser composite processing structured electrode for an alkali metal battery prepared in Example 1 of the present disclosure.

FIG. 3 is a schematic assembly diagram of a sodium-ion half-cell in an embodiment of the present disclosure.

FIG. 4 is a schematic structural diagram of an array ring electrode in Example 4 of the present disclosure.

FIG. 5 is a schematic structural diagram of a square electrode in Example 5 of the present disclosure.

FIG. 6 is a comparison chart of rate performances of sodium-ion batteries based on a 3D printing-laser composite processing structured electrode, a 3D printed electrode (Comparative Example 1) and a planar electrode (Comparative Example 2) in Example 2.

FIG. 7 is a cycle performance curve chart of a sodium-ion half-cell based on a 3D printing-laser composite processing structured electrode prepared in Example 2 under a current condition of 100 mA·g⁻¹.

FIG. 8 is a cycle performance curve chart of a sodium-ion half-cell based on a 3D printed electrode prepared in Comparative Example 1 under a current condition of 100 mA·g⁻¹.

FIG. 9 is a cycle performance curve chart of a sodium-ion half-cell based on a planar electrode prepared in Comparative Example 2 under a current condition of 100 mA·g⁻¹.

### REFERENCE SIGNS

1—cross section of electrode body, 2—cross section of etched structure, 3—electrode body, 4—etched structure, 5—upper battery case, 6—gasket, 7—elastic sheet, 8—sodium sheet, 9—lower battery case, 10—electrolyte, 11—3D printing-laser composite processing structured electrode, 12—separator.

### DETAILED DESCRIPTION

The concepts and achieved technical effects of the present disclosure are clearly and completely described below in combination with examples, so as to fully understand the purposes, features and effects of the present disclosure. It is apparent that the described examples are only a part of the examples of the present disclosure but not all of the examples. Based on the examples of the present disclosure, all the other examples obtained by those skilled in the art without creative effort should belong to the scope of protection of the present disclosure.

In the description of the present disclosure, the descriptions of reference terms “one embodiment”, “some embodiments”, “schematic embodiment”, “example”, “specific example”, or “some examples” intend to be included in at least one embodiment or example of the present disclosure in combination with the specific characteristics, structures, materials or characteristics of this embodiment or example. In this specification, the schematic expression of the above terms does not need for the same embodiment or example. Moreover, the described specific characteristics, structures, materials or characteristics may be combined in one or more embodiments or examples in a suitable manner.

It should be understood that the scope of protection claimed by the present disclosure is not limited to the scope of the examples. If there are any matters not specified, those skilled in the art can refer to relevant technologies to implement or understand the matters. The reagents and instruments used are commercially available.

All the hard carbon, conductive carbon black and polyvinylidene fluoride used in examples of the present disclosure are purchased from Shenzhen Kejing Co., Ltd, China.

In the embodiment of the present disclosure, the length and width of the nickel foam match the material table size (15 cm*10 cm) of the 3D printer provided by Business Department of Kunshan Guangjiayuan Electronic Materials, China.

The specific examples of the present disclosure are described in detail as follows.

### EXAMPLE 1

A preparation method for a structured electrode was provided in this example, which included the following steps:
S1. Preparation of slurry:
8 g of hard carbon, 1 g of conductive carbon black, 1 g of polyvinylidene fluoride and 15 mL of N-methylpyrrolidone were taken and placed into a special cup for a deforming stirrer, processed for 60 min with a high-speed stirrer at a stirring speed of 2000 rpm for uniform mixing, and then deformed for 5 min at a stirring speed of 3000 rpm.
S2. Preparation of an electrode body by 3D printing:
Nickel foam with a thickness of 0.5 cm was taken as a current collector of the electrode body, the slurry prepared in step S1 was taken as the slurry for the 3D printing and placed in a 3D printing base material cylinder with a nozzle diameter of 600 μm to print a three-dimensional electrode of a three-dimensional array line (a line width of 600 μm, a thickness of 600 μm) with a connected spacing of 1.5 mm on the current collector to obtain the electrode body, wherein the printing parameters were set as: a printing speed of 20 mm/s, an air pressure of 14 psi, an elevation height of the contact point between the nozzle and the nickel foam of 0.6 mm.
S3. Laser etching:
A linear array with a spacing of 0.4 mm was drawn by using a laser drawing software Ez Cad 2.7.6 configured for a pulse laser device, wherein a total width of the linear array was more than a width of the electrode prepared by 3D printing, an etching thickness was 100 μm, and the linear array was perpendicular to the array line in the electrode body in step S2; the laser processing parameters including a processing rate of 200 mm/s, a processing power of 6 W, and a frequency of 20 kHz were set; and the electrode body obtained in step S2 was etched according to the drawn pattern by using the laser device.
S4. The electrode that was subjected to laser etching in step S3 was washed with water and dried at a temperature of 80° C. for 10 h to obtain a structured electrode, wherein compared with the electrode prepared by 3D printing, a specific surface area of the structured electrode was improved by 80%.

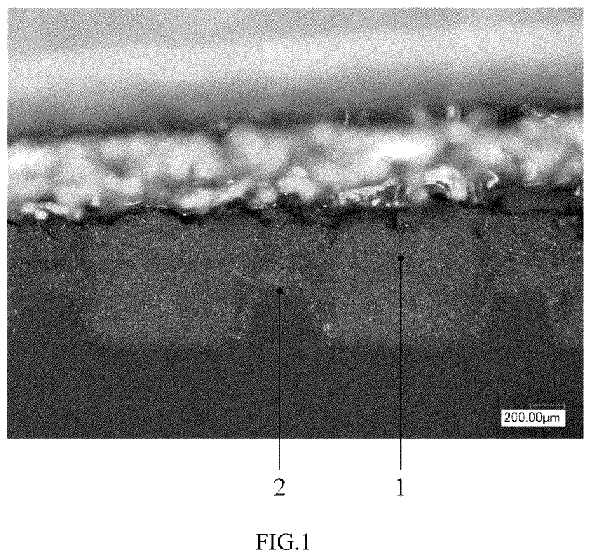

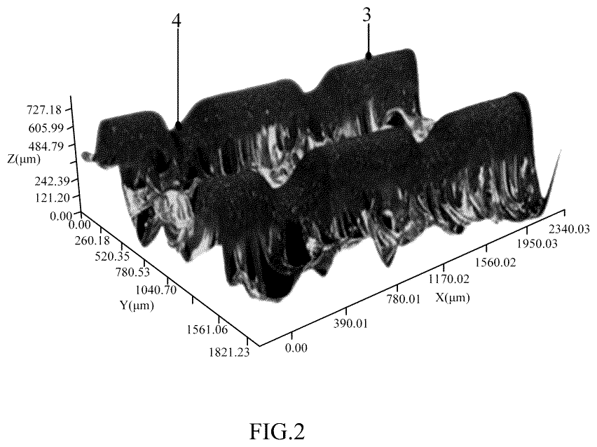

The schematic structural diagram of the 3D printing-laser composite processing structured electrode of the alkali metal battery prepared in this example can be seen in FIG. 1 and FIG. 2. It can be seen from FIG. 1 and FIG. 2 that the prepared structured electrode includes an electrode body 3 (where 1 is a cross section of the electrode body), and an etched structure 4 provided on a surface of the electrode body 3 (2 is a cross section of the etched structure). The schematic structural diagram in the embodiment of the present disclosure is only used to illustrate the etching shape and does not limit the specific size.

### EXAMPLE 2

A preparation method for a structured electrode was provided in this example, which included the following steps:
S1. Preparation of slurry:
7 g of hard carbon, 2 g of conductive carbon black, 2 g of polyvinylidene fluoride and 17 mL of N-methylpyrrolidone were taken and placed into a special cup for a deforming stirrer, processed for 90 min with a high-speed stirrer at a stirring speed of 2500 rpm for uniform mixing, and then deformed for 5 min at a stirring speed of 3000 rpm.
S2. Preparation of a three-dimensional electrode by 3D printing:
Nickel foam with a thickness of 0.5 cm was taken as a current collector of the three-dimensional electrode, the slurry prepared in step S1 was taken as the slurry for the 3D printing and placed in a 3D printing base material cylinder with a nozzle diameter of 150 μm to print the three-dimensional electrode of a three-dimensional array line (a line width of 150 μm, a thickness of 150 μm) with a spacing of 1.2 mm on the current collector to obtain the electrode body, wherein the printing parameters were set as: a printing speed of 20 mm/s, an air pressure of 55 psi, an elevation height of the contact point between the nozzle and the nickel foam of 0.15 mm.
S3. Laser etching:
A rectangular array with a spacing of 1 mm and a width of 0.2 mm was drawn by using a laser drawing software Ez Cad 2.7.6 configured for a pulse laser device, wherein the rectangular array was an array of multiple rectangles with a spacing of 1 mm in the x-axis direction, and an etching thickness was 100 μm; the laser processing parameters including a processing rate of 150 mm/s, a processing power of 16 W, a frequency of 20 kHz were set; and the electrode body obtained in step S2 was etched according to the drawn pattern by using the laser device.
S4. The electrode that was subjected to laser etching in step S3 was washed with deionized water and dried at a temperature of 60° C. for 12 h to obtain the 3D printing-laser composite processing structured electrode, wherein compared with the electrode prepared by 3D printing, a specific surface area of the 3D printing-laser composite processing structured electrode was improved by 60%.

The 3D printing-laser composite processing structured electrode of the alkali metal battery in this example includes a 3D printed electrode body structure and a laser etched structure; and the laser etched structure is obtained by laser etching on the 3D printed electrode body structure.

### EXAMPLE 3

An alkali metal battery was provided in this example.

The 3D printing-laser composite processing structured electrode prepared in Example 2 was used to prepare a sodium-ion half-cell comprising the 3D printing-laser composite processing structured electrode in Example 2 as a cathode and a sodium sheet as an anode. When assembling the battery, the 3D printing-laser composite processing structured electrode prepared in Example 2 was used as a cathode of a sodium-ion battery, the 3D printed electrode body structure and the laser etched structure were in direct contact with a separator, and the base nickel foam was in direct close contact with a battery case.

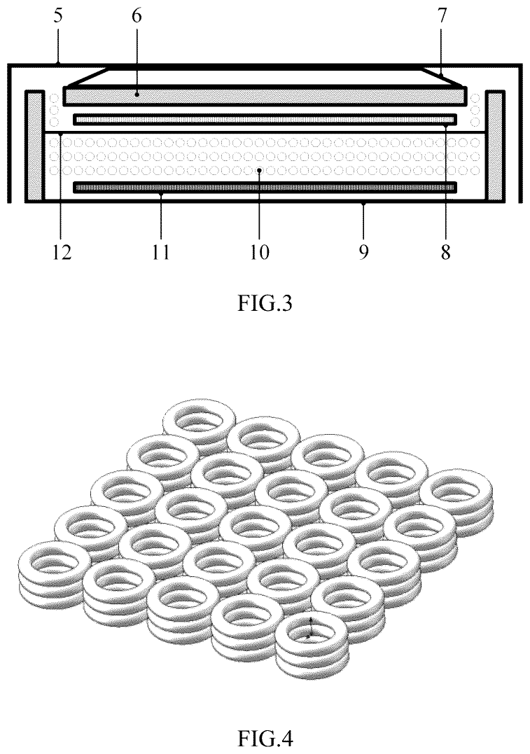

FIG. 3 is a schematic assembly diagram of a sodium-ion half-cell comprising a 3D printing-laser composite processing structured electrode. As shown in FIG. 2, an electrode sheet 9 is placed on a lower battery case 7, an electrolyte 9 directly infiltrates active materials on the electrode sheet 9, the electrolyte 8 fills the entire cavity composed of the electrode sheet 9, the lower battery case 7 and a separator 10. A sodium sheet 6 is tightly attached to the separator 10, a gasket 4 and an elastic sheet 5 are sequentially placed on an upper surface of the sodium sheet 6 from bottom to top, the gasket 4 and the elastic sheet 5 are configured to adjust the pressure of the battery, and the elastic sheet 5 is in close contact with an upper battery case 3 to reduce the contact resistance and ensure good conductivity inside the battery.

When the prepared sodium-ion half-cell comprising the 3D printing-laser composite processing structured electrode is discharged, the sodium sheet 6 begins to remove sodium, sodium ions enter the electrolyte 8 through the separator 10, and then come into contact with the active materials on the electrode sheet 9 and are embedded in the active materials; meanwhile, electrons enter the lower battery case 7 through the gasket 4, the elastic sheet 5 and the upper battery case 3 in turn; since the lower battery case 7 is in close contact with the electrode sheet 9, the electrons then enter the active materials of the electrode sheet 9 and neutralize the charge with the sodium ions, to complete the discharging process of the sodium-ion half-cell. When the sodium-ion half-cell is charged, the sodium ions are first embedded from the active materials on the electrode sheet 9, enter the electrolyte 8, and then come into contact with the sodium sheet 6 through the separator 10; and the electrons are transferred from the active materials on the electrode sheet 9, and pass through the lower battery case 7, the upper battery case 3, the elastic sheet 5 and the gasket 4 in turn for performing a charge balance with the sodium ions on the sodium sheet 6, thus completing the charging process.

The rate performance and cycle performance of the sodium-ion half-cell based on the 3D printing-laser composite processing structured electrode were tested by the LAND CT2001A battery testing system.

### EXAMPLE 4

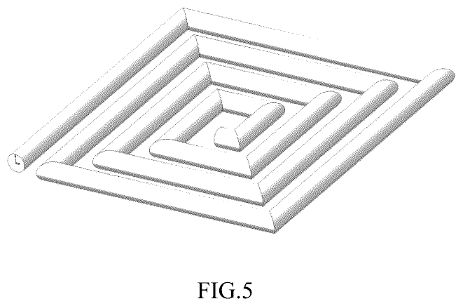

A preparation method for a structured electrode was provided in this example, and this example differed from Example 1 in that: in this example, the electrode body was an array ring electrode, and the schematic structural diagram of the array ring electrode in this example was shown in FIG. 4.

In this example, the 3D printing path was only needed to be switched as a ring shape as shown in FIG. 4. A procedure of the printing path in the 3D printer was changed to a procedure for printing the array ring printing, and the printing parameters of the array ring were set as below: a diameter of 1.5 mm, and the setting procedures for the rest parameters were the same as those in Example 1.

### EXAMPLE 5

A preparation method for a structured electrode was provided in this example, and this example differed from Example 1 in that: in this example, the electrode body was a square electrode, and the schematic structural diagram of the square electrode in this example was shown in FIG. 5.

In this example, the 3D printing path was only needed to be switched as a square spiral line as shown in FIG. 5. A procedure of the printing path in the 3D printer was changed to a procedure for printing the square spiral line ring, and the printing parameters of the square spiral lines were set as below: a width of the outer side length of the square of 12 mm, the spacing between the spiral lines of 1.5 mm, and the setting procedures for the rest parameters were the same as those in Example 1.

### COMPARATIVE EXAMPLE 1

A sodium-ion half-cell comprising a 3D printed electrode was provided in this comparative example, and this comparative example differed from example 1 in that: steps S3 and S4 were not carried out in this comparative example; that is, the drying treatment was performed after step S2 was completed, with a drying temperature of 80° C. and a drying time of 10 h.

The assembly method of the sodium-ion half-cell in this comparative example is as shown in FIG. 3.

### COMPARATIVE EXAMPLE 2

A sodium-ion half-cell comprising a planar electrode was provided in this comparative example.

Raw materials for preparing the planar electrode in this comparative example were: 7 g of hard carbon, 2 g of conductive carbon black, 2 g of polyvinylidene fluoride and 15 mL of N-methylpyrrolidone.

The assembly method of the sodium-ion half-cell in this comparative example is as shown in FIG. 3.

7 g of hard carbon, 2 g of conductive carbon black, 2 g of polyvinylidene fluoride and 15 mL of N-methylpyrrolidone was taken and placed into a special cup for a high-speed stirrer, processed for 30 min with a high-speed stirrer at a stirring speed of 3000 rpm for uniform mixing, and then deformed for 5 min at a stirring speed of 3000 rpm to obtain a mixed slurry. In this comparative example, an automatic coating machine was used as a coating device for the planar electrode, and nickel foam was used as a current collector and flatly placed on a sample stage of the automatic coating machine. A 100 μm four-sided coater was selected to apply the slurry to one side of the four-sided coater, the automatic coating machine was activated to drive the four-sided coater to evenly coat the slurry on the nickel foam with a coating thickness of 100 μm; and a drying treatment was performed for 10 h at 80° C.

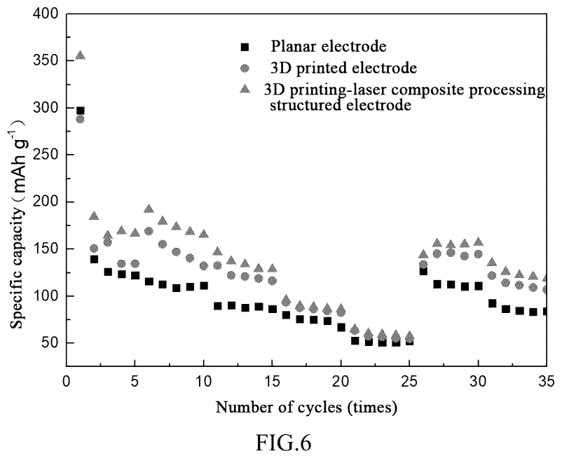

FIG. 6 is a rate performance comparison curve of a sodium-ion half-cell of a structured electrode prepared in Example 2. It can be seen from FIG. 6 that the sodium-ion half-cell based on the 3D printing-laser composite processing structured electrode in Example 2 has a discharge capacity of 166.7 mAh/g, 165.2 mAh/g, 128.7 mAh/g, 86.3 mAh/g, 57.4 mAh/g, 156.9 mAh/g and 118.6 mAh/g at a rate cycle of 30 mA/g, 50 mA/g, 100 mA/g, 200 mA/g, 500 mA/g, 50 mA/g and 100 mA/g respectively, which is higher than that of the sodium-ion half-cell based on the 3D printed electrode (in Comparative example 1, the discharge capacity is 134.6 mAh/g, 132.2 mAh/g, 116.3 mAh/g, 79 mAh/g, 54.7 mAh/g, 144.6 mAh/g and 106.8 mAh/g respectively), and higher than that of the sodium-ion half-cell based on the planar electrode (in Comparative example 2, the discharge capacity is 122.2 mAh/g, 111.4 mAh/g, 86.6 mAh/g, 67.2 mAh/g, 52.2 mAh/g, 111.2 mAh/g and 83.9 mAh/g respectively). Thus, it shows that the rate performance of the sodium-ion half-cell comprising the structured electrode obtained in Example 2 of the present disclosure is significantly improved, duce to the coupling effect of the 3D printed electrode body structure and the laser etched structure.

The 3D printing-laser composite processing structured electrode of the alkali metal battery prepared in Example 1 has similar effects to that of Example 2, referring to FIG. 6.

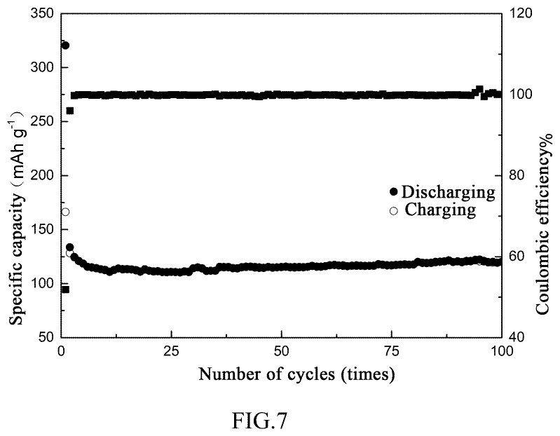

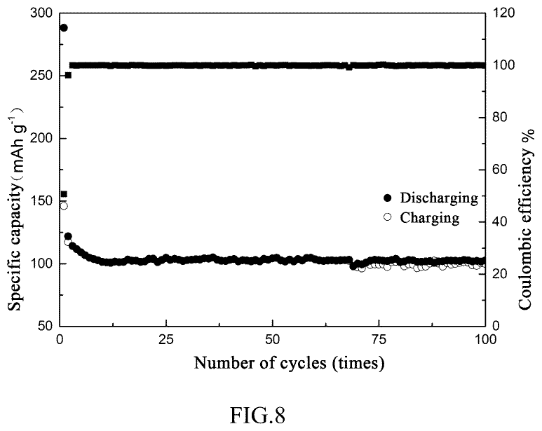

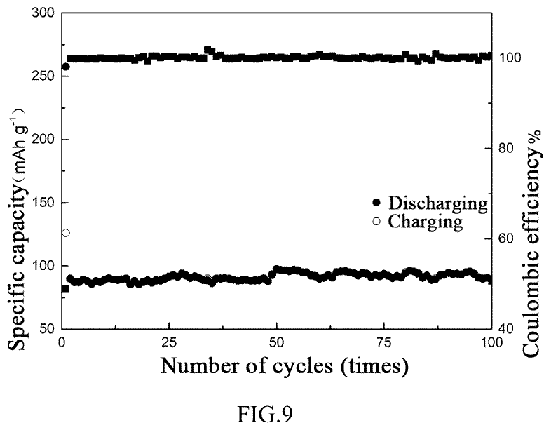

FIG. 7 is a cycle performance curve chart of a sodium-ion half-cell based on the 3D printing-laser composite processing structured electrode prepared in Example 2 under a current condition of 100 mA·g⁻¹. It can be seen from FIG. 7 that the prepared sodium-ion half-cell based on the 3D printing-laser composite processing structured electrode has a reversible capacity reaching 120.1 mAh/g (as shown in FIG. 7) after 100 cycles at a current of 100 mA/g, and the capacity retention rate is up to 37.47%. However, under the same conditions, the sodium-ion half-cell based on the 3D printed electrode has a reversible capacity of only 102.5 mAh/g (as shown in FIG. 8), and the capacity retention rate is only 35.56%; and the sodium-ion half-cell based on the planar electrode is only 88.9 mAh/g (as shown in FIG. 9), and the capacity retention rate is only 34.52%. The results show that the 3D printing-laser composite processing structured electrode not only helps to improve the charge-discharge specific capacity of the sodium-ion half-cell, but also helps to improve the cycle stability of the battery and prolongs the battery life.

The 3D printing-laser composite processing structured electrode of the alkali metal battery prepared in Example 1 has similar effects to that in Example 2, as shown in FIG. 7, FIG. 8 and FIG. 9.

To sum up, the 3D printing-laser composite processing structured electrode of the alkali metal battery provided by the present disclosure has superior electrochemical performances compared with the sodium-ion half-cell based on the 3D printed electrode and planar electrode, and therefore the prepared sodium-ion half cell has better cycle stability and longer cycle life.

The embodiments of the present disclosure are described in detail above in combination with the specific implementations, and however the present disclosure is not limited to the above examples. Under the premise of not departing from the purpose of the present disclosure, various changes may also be made within the knowledge scope of those skilled in the art. In addition, the examples in the present disclosure and features in the examples may be combined with each other without conflict.

1. A structured electrode, comprising an electrode body, wherein a surface of the electrode body is provided with an etched structure; and the electrode body is an array structure composed of three-dimensional electrode wires.

2. The structured electrode according to claim 1, wherein the electrode body is at least one selected from the group consisting of a line array, a ring array and a grid array; and the three-dimensional electrode wires are 0.1 mm-1 mm in width.

3. The structured electrode according to claim 1, wherein the etched structure comprises at least one selected from the group consisting of a line array, a grid array and a hole array.

4. The structured electrode according to claim 1, wherein raw materials for preparing the electrode body comprises an electrode material, a conductive agent, an adhesive and a solvent.

5. A method for preparing the structured electrode according to claim 4, comprising the following steps:
printing the electrode body on a surface of a current collector by 3D printing, then etching the electrode body with a laser device, and drying the electrode body;
wherein the drying is conducted at a temperature of 50° C.-150° C. for 4 h-12 h.

6. The method according to claim 5, wherein the current collector comprises any one selected from the group consisting of copper foil, aluminum foil, nickel foam, copper foam and carbon cloth.

7. The method according to claim 5, wherein a preparation method of the electrode body comprises the following steps: mixing the electrode material, the conductive agent, the adhesive and the solvent, and defoaming a resulting mixture to obtain a mixed slurry.

8. The method according to claim 5, wherein the laser device comprises at least one selected from the group consisting of a semiconductor laser device and a carbon dioxide laser device.

9. The method according to claim 5, wherein the 3D printing has the following process parameters:
a printing speed of 5 mm/s-60 mm/s; a pressure of 5 psi-80 psi; and a horizontal height between a nozzle and the current collector of 0.1 mm-1 mm.

10. An alkali metal battery, comprising the structured electrode according to claim 1.

11. The structured electrode according to claim 3, wherein the line array comprises at least one selected from the group consisting of a linear array, a diagonal array and a curved array; the grid array comprises at least one selected from the group consisting of a rectangular array and a trapezoidal array; and the hole array comprises at least one selected from the group consisting of a blind hole array and a through hole array.

12. The structured electrode according to claim 11, wherein the blind hole array comprises at least one selected from the group consisting of a circular blind hole array, a square blind hole array and a special-shaped blind hole array; and the through hole array comprises at least one selected from the group consisting of a circular through hole array, a square through hole array and a special-shaped through hole array.

13. The structured electrode according to claim 3, wherein an etched line width of the etched structure is 10%-100% of the width of the three-dimensional electrode wires in the electrode body; and a spacing between adjacent units in the etched structure is 1-10 times of the etched line width.

14. The structured electrode according to claim 4, wherein the electrode body comprises the following raw materials in parts by weight: 60-90 parts of electrode material, 5-20 parts of conductive agent and 5-20 parts of adhesive.

15. The structured electrode according to claim 4, wherein the electrode material is an alkali metal battery electrode material; and the alkali metal battery electrode material comprises a lithium-ion electrode material and a sodium-ion electrode material.

16. The structured electrode according to claim 15, wherein the lithium-ion electrode material is at least one selected from the group consisting of lithium iron phosphate, lithium manganese phosphate, lithium manganate, lithium iron silicate, lithium manganese silicate, lithium nickel cobalt manganese oxide, lithium nickel manganate and lithium titanate;
and the sodium-ion electrode material comprises at least one selected from the group consisting of hard carbon and titanium dioxide.

17. The structured electrode according to claim 4, wherein the conductive agent comprises at least one selected from the group consisting of acetylene black, carbon black, graphene, carbon fiber, carbon nanotube, Fe powder, Cu powder, Ag powder and Ni powder; the adhesive comprises at least one selected from the group consisting of polytetrafluoroethylene, low-pressure polyethylene, polyvinylidene fluoride and polyvinyl alcohol; and the solvent comprises water or N-methylpyrrolidone.

18. The method according to claim 5, wherein the current collector is 35 μm-2000 μm in thickness.

19. The method according to claim 7, wherein the mixing is conducted at a stirring speed of 2000 rmp-3000 rpm; and the mixing is conducted for 10 min-60 min.

20. The method according to claim 7, wherein the defoaming is conducted at a stirring speed of 1000 rmp-3000 rpm; and the defoaming is conducted for 5 min-60 min.
